(19) United States
(12) Patent Application Publication
(10) Pub. No.: US 2005/0178565 A1
(43) Pub. Date: Aug. 18, 2005

(54) Fire line dispersal system

(75) Inventor: Timothy H. Voss, Fairfield, PA (US)

Correspondence Address: MCNEES, WALLACE & NURICK LLC, 100 PINE STREET, P.O. BOX 1166, HARRISBURG, PA, 17108-1166, US

(73) Assignee: Agrotors, Incorporated, Gettysburg, PA (US)

(21) Appl. No.: 10/715,298

(22) Filed: Nov. 17, 2003

Related U.S. Application Data
(60) Provisional application No. 60/427,587, filed on Nov. 19, 2002.

(51) Int. Cl. A62C 25/00; A62C 27/00; A62C 29/00

(52) U.S. Cl. 169/53; 169/52; 169/51

(57) ABSTRACT

A fire suppression dispersal system for an airborne craft which applies fire suppressant material at or near ground level. The system includes a vessel that is secured within or adjacent the airborne craft for holding a fire suppressant material therein. A dispenser controllably dispenses the material from the vessel. A conduit has a first end secured in fluid communication with the vessel and a second end connected to a dispensing end for controllably directing the dispensed material at or near ground level. The dispensing end which dispenses fire suppressant material is enclosed within a protective shroud for impact protection from the encountered terrain.

### FIELD OF THE INVENTION

The present invention relates generally to fire suppression systems delivered by airborne craft, and more particularly to fire line dispersal systems delivered by airborne craft wherein the fire suppressant is controllably delivered along or adjacent ground level.

### BACKGROUND OF THE INVENTION

Every year, millions of acres of wildland in the United States are destroyed by fire, averaging more than 3.19 million acres for each ten year period since 1919, 1918 being the first year such records were kept. These fires have many adverse environmental and economic effects. In an effort to contain such fires, fire hand crews, typically consisting of approximately twenty individuals, are organized for battling a particular fire, or incident. Crew members are often tasked with creating a fire break, which typically consists of clearing undergrowth, such as leaves, needles, or smaller branches dropped by adjacent trees, brush and overgrown grasses, not to mention fallen trees. Preferably, a swath of at least three feet in width is cleared along a perimeter of the fire's anticipated path down to mineral soil. It has been shown that providing at least one, and preferably a series of adjacent, parallel spaced fire breaks is effective in slowing down these fires, which is a critical step for fire containment. Not surprisingly, this activity is predominantly physical, the crew members utilizing unique hand tools, such as a “Pulaski,” named for its developer, which incorporates a combination tool, ax and mattock which enables the cutting of trees and limbs, as well as digging and scraping with the mattock side of the tool. In addition to being physically demanding, changing weather conditions, including direction and magnitude of the wind, may endanger the well-being of these crews, possibly requiring timely air lifting from the fire break areas, which are typically located in such isolated, rugged terrain regions as to be otherwise impassible by land. Therefore, it is highly desirable to find alternate ways to create fire breaks without requiring fire crews.

Mechanized fire suppression devices are known in the art, such as employing buckets suspended from beneath airborne craft such as helicopters, for providing repetitive dumping “runs” between an existing water source and fire. However, this technique is not effective for providing a fire break, typically the load being dropped entirely, or at least substantially, in an extremely localized area. In addition, it is extremely difficult, if not impossible, for the helicopter pilot to make a “run,” leaving the area to refill the bucket, returning to that area, and accurately determining which portions of the area had been covered by the previous run, which is necessary to apply a contiguous line of fire suppressant. It has been found that a focused application of fire suppressant, especially nitrogen-based formulations of the consistency of a slurry mix, along a narrow path, preferably applied along or adjacent ground level can be effective in forming a fire break. However, the above technique of fire suppression applies the fire suppressant in a macro scale from considerable height, that is, the bucket is positioned at least above tree top level.

Other fire suppression equipment may employ a receptacle for securing compartments of water and fire suppressant on board a helicopter for mixing the water and fire suppressant upon demand. The mixture, such as foam, is dumped from the bottom of the compartment, or applied through a hose secured by a boom that is pivotally mounted to the aircraft structure for providing a focused spray to the desired location (see U.S. Pat. Nos. 3,494,423, 3,714,987 and 3,897,829). Each of the fire suppression constructions disclosed in these references are similarly of limited use for forming fire breaks due to their inability to apply directed fire suppressant material along or near ground level because the terrain, especially heavily wooded areas, prevent such access.

U.S. Pat. No. 5,385,208 is directed to a foam delivery apparatus carried as a slung bucket that is adapted to be utilized near ground level. The delivery apparatus includes a pressure vessel containing air cylinders for holding high pressure air therein, the pressure vessel being configured to hold a quantity of water therein, the air cylinders being submerged and surrounded by the water. Nozzle assemblies extending from the bottom of the bucket deliver pressurized foam to a fire. Surrounding the nozzle assemblies for protection from impact with objects is an apron further surrounded by a support frame that surrounds both the apron and the bucket. However, this construction subjects a large pressure vessel securing fire suppressant material and additional tanks which may contain gas under extremely high pressure to damage by collision with terrain, potentially containing jutting timber, rocks or any number of other pointed obstructions. Further, due to the necessary size of the vessel as disclosed, the difficulty of manipulating the vessel in heavily wooded terrain is significantly increased.

There is an need in the art for a distribution system suspended from an airborne craft for controllably dispensing fire suppressant material along or near ground level which employs a minimum of equipment that extends from the airborne craft which is small, inexpensive to manufacture, easily movable, and permitting ease of controlled, traceable, and adjustable application of fire suppressant material.

### SUMMARY OF THE INVENTION

The present invention relates to a dispersal system for fire suppression material for use with an airborne craft including a vessel for holding at least one fire suppressant material therein, the vessel being secured within or adjacent to an airborne craft. A dispenser controllably dispenses the at least one fire suppressant material from the vessel. A conduit having a first end is secured in fluid communication with the vessel and a second end is adapted for controllably directing the dispensed material adjacent to ground level.

The present invention further relates to a dispersal system for fire suppression including an airborne craft and a vessel secured within or adjacent to the airborne craft for holding at least one fire suppressant material therein. A dispenser controllably dispenses the at least one fire suppressant material from the vessel. A conduit having a first end is secured in fluid communication with the vessel and a second end having a valve and a dispensing end controllably directs the dispensed material adjacent to ground level. A shroud surrounds the valve and dispenser head. A release mechanism is secured to the airborne craft that is interposed between the vessel and the conduit for separation of the conduit from the airborne craft.

Among the principal advantages of the present invention is the provision of a fire suppression system which employs a minimum of equipment extending from an airborne craft which is small, inexpensive to manufacture, easily movable, and permitting ease of controlled, traceable, and adjustable application of fire suppressant material.

Other features and advantages of the present invention will be apparent from the following more detailed description of the preferred embodiment, taken in conjunction with the accompanying drawings which illustrate, by way of example, the principles of the invention.

### BRIEF DESCRIPTION OF THE DRAWINGS

FIG. 1 is a perspective view of a prior art sprayer system attached to a helicopter.

FIG. 2 is a perspective view of the fire dispersal system of the present invention.

FIG. 3 is an enlarged elevation view of a release mechanism of the present invention.

FIG. 4 is an enlarged perspective view of a dispensing end of the present invention.

FIG. 5 is a perspective view of an alternate embodiment of the dispensing end of the present invention.

FIG. 6 is a perspective view of another alternate embodiment of a dispensing end of the present invention.

FIG. 7 is a perspective view of yet another alternate embodiment of a dispensing end of the present invention.

FIG. 8 is a perspective view of still another embodiment of a dispensing end of the present invention.

FIG. 9 is an elevation cross sectional view of the dispensing end of the present invention.

FIG. 10 is a perspective view of a protective frame for the alternate embodiment of the present invention.

FIG. 11 is an elevation view of a helicopter carrying an alternate fire dispersal system of the present invention.

FIG. 12 is an enlarged elevation view of the alternate fire dispersal system of the present invention.

FIG. 13 is a cutaway elevation view of the alternate fire dispersal system of the present invention.

FIG. 14 is a plan view looking up into the alternate fire dispersal system of the present invention.

Wherever possible, the same reference numbers will be used throughout the drawings to refer to the same or like parts.

### DETAILED DESCRIPTION OF THE INVENTION

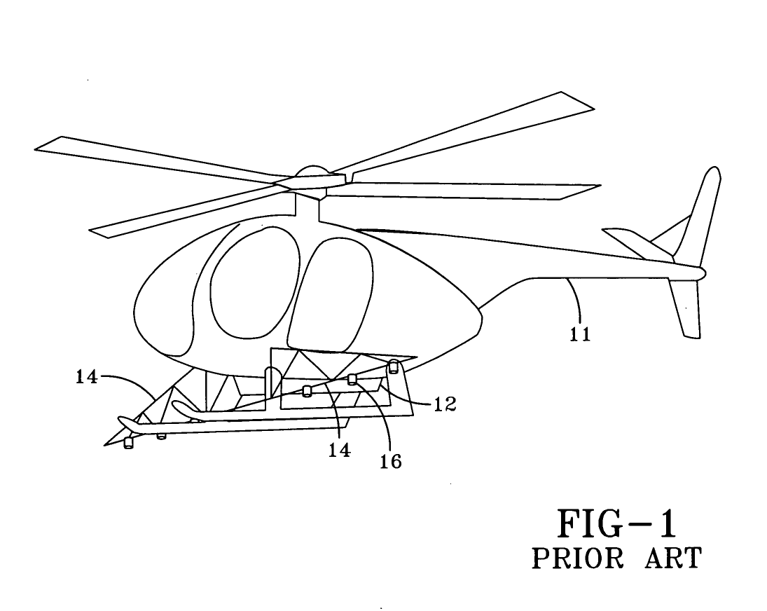

Referring to FIG. 1, a prior art spraying system is depicted. The prior art spraying system includes a helicopter 11 having a vessel 12 secured to the underside structure of helicopter 11 for holding a chemical, such as fire suppressant or fire suppressant material, therein. Extending laterally outward from each side the helicopter belly structure are a pair of booms 14, typically of truss member construction, provided with a plurality of nozzles 16 secured to the lower portion of the booms for dispensing the fire suppressant therefrom by a pumping system (not shown). An example of a spraying system described herein is manufactured by Simplex Manufacturing of Portland, Oreg. This spraying system as supplied does not permit the helicopter pilot to apply or “lay down” an effective fire line due to the inability to apply fire suppressant along or adjacent to ground level.

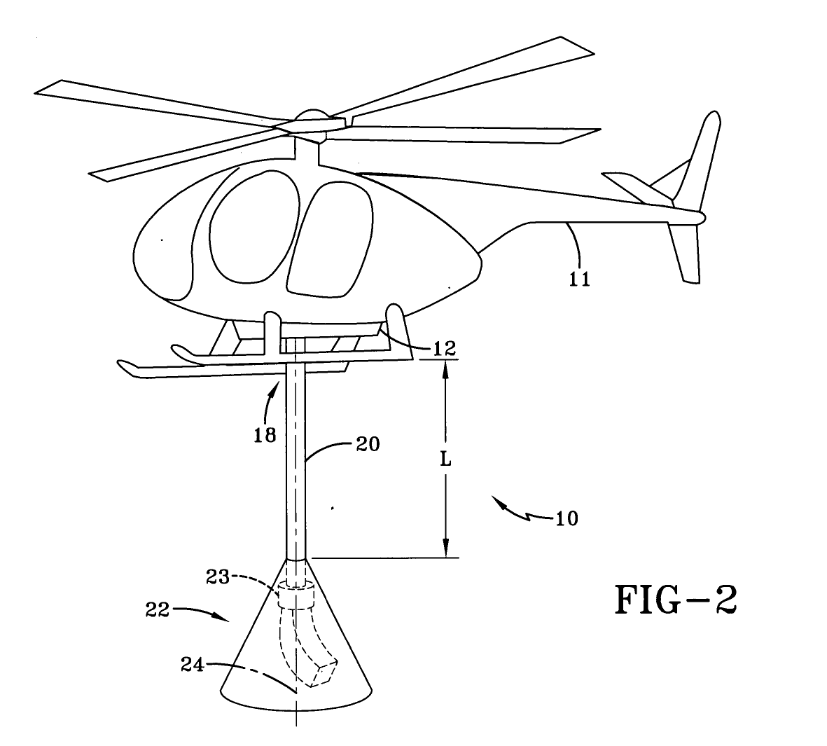

However, referring to FIG. 2, the fire line dispersal system 10 of the present invention shall now be discussed which is specially adapted to apply fire suppressant along or adjacent to ground level. While employing most of the standard components of the aforementioned spraying system, that is, vessel 12 and pumping system, fire line dispersal system 10 includes a release mechanism 18 releasably securing an extended length of hose 20 to vessel 12 so that dispersal system 10 may be disengaged from helicopter 11 in case of an emergency. Hose 20 terminates at a distal end 23 adjacent a durable impact resistant dispensing end 22 having a valve 50 (FIG. 4) interposed therebetween for permitting precise, thorough, controlled application of pressurized fire suppressant from the pumping system to create a desired fire break along or near ground level by dispensing fire suppressant material therealong, or multiple fire breaks as desired, irrespective the terrain.

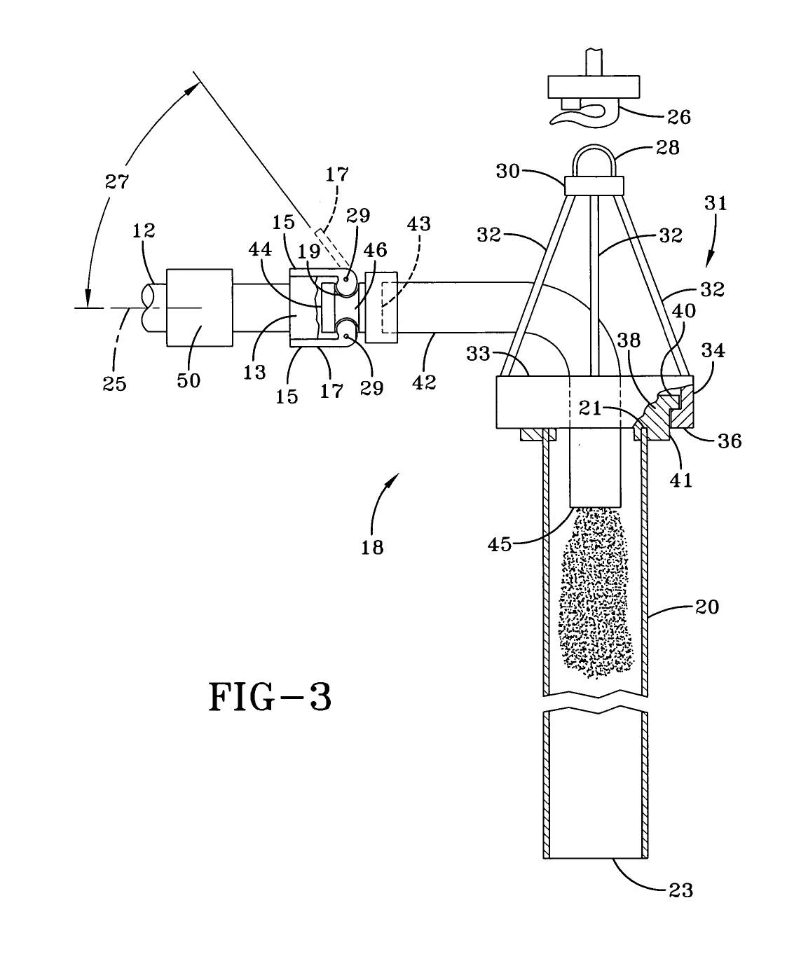

Referring to FIG. 3, release mechanism 18 shall now be discussed. Release mechanism includes a tubing segment 42 having a proximal end 43 secured to vessel 12 and a distal end 45 secured in fluid communication with hose 20 for transporting fire suppressant between vessel 12 and hose 20. A grooved fitting 44 having an annular groove 46 formed therein is secured over proximal end 43 which is then directed in substantial alignment with a central axis 25 inside a quick disconnect fitting 13 for engaging the grooved fitting 44, such as by opposed hinged cam lock fasteners 15. Grooved fitting 44 is further directed inside fitting 13 until annular groove 46 is aligned with cam portions 19 of cam lock fasteners 15. In this aligned position, arms 17 of cam lock fasteners 15, previously positioned at an angle 27 to central axis 25 to permit entry of grooved fitting 44 inside fitting 13, are directed into hinged rotation about pin 29 toward fitting 13 until arms 17 are substantially parallel to central axis 25. With arms 17 in this “closed” position, cam portions 19 of cam lock fasteners 15 are brought into engagement within groove 46, thereby securing vessel 12 to proximal end 43 of tubing segment 42. Interposed between fitting 13 and vessel 12 is a valve 50 actuated by actuating means. This actuating means may be electrical, hydraulic or mechanical. When the actuating means is electrically powered, it is preferably powered by a 24 volt electrical source that is typically supplied by helicopter electrical systems for shutting off flow of pressurized fire suppressant from vessel 12 in an emergency. Distal end 45 of tubing segment 42 is inserted into a proximal end 21 of hose 20 and is secured therein by a harness 31.

Harness 31 includes an eyelet 28 which is secured within a cargo hook 26 that extends from the understructure of helicopter 11. In an emergency, eyelet 28 may be disconnected from hook 26, which may be accomplished by hook 26 or eyelet 28 being adapted to be controllably actuated into an “open” position by the pilot, or designing hook 26 or eyelet 28 to structurally deflect in response to a predetermined tensile load so that the desired disconnection is effected. Alternately, eyelet 28 may be configured to structurally fail in response to a predetermined tensile load to effect the desired disconnection. Eyelet 28 is secured to a ring 30 which is further secured to a flanged collar 34 by a plurality of cables 32 for supporting hose 20. Collar 34 includes an inwardly directed flange 36. An end fitting 38 which is secured over proximal end 21 of hose 20 includes a flange 40 that extends in a radially outward direction. Distal end 23 of hose 20 as well as the portion of end fitting 38 having an outside diameter 41 may be inserted through an upper end 33 of collar 34. However, since the outside diameter of flange 40 is greater than the inside diameter of flange 36, fitting 38 is structurally carried by/within collar 34. Once fitting 38 has been secured within collar 34, prior to connecting eyelet 28 with hook 26, distal end 45 of tubing segment 42 is directed between cables 32 and incrementally inserted inside collar 34, fitting 38 and hose 20. Once distal end 45 has been sufficiently inserted inside hose 20, which ensures that tubing segment 42 is in fluid communication with vessel 12 and hose 20, eyelet 28 may then be connected to hook 26 which secures tubing segment 42 in its installed “operational” position.

Referring to FIGS. 2-4, hose 20 shall now be discussed. Hose 20 delivers the fire suppressant material to dispensing end 22 once fire suppressant material has passed from vessel 12 through tubing segment 42. It is the extended length “L” of hose 20 which permits the pilot (not shown) of helicopter 11 to safely and accurately position dispensing end 22 at or near ground level for controllably applying fire suppressant thereto. Hose 20 may be from about fifty to about one hundred fifty feet in length, preferably about one hundred feet. As hose 20 length is decreased below about fifty feet, the flow of the fire suppressant exiting dispensing end 22 may be affected by “rotor wash,” that is, the air stream predominantly beneath the helicopter rotors that is directed downwardly in response to the rotating angled rotor blades of helicopter 11 which are employed to maintain helicopter 11 in airborne flight. However, as the length of hose 20 significantly exceeds one hundred fifty feet in length, the weight of hose 20 as well as the weight of fire suppressant carried therein, which is in addition to the weight of dispensing end 22 may require increased hose wall thickness. Further, this increased hose length likewise necessarily increases the distance between the pilot and dispensing end 22, the pilot monitoring the path of dispensing end 22 using vertical reference techniques well known in the art by viewing dispensing end 22 through the “bubble window” typically provided in the helicopter door. Another factor possibly limiting hose length is the probability of increased lateral deflection from central axis 24 when certain embodiments of dispensing end 22 are employed as is discussed in additional detail below, not to mention the possibility of increased effects by vibration or pressure loss of pressurized fire suppressant along hose 20.

Referring to FIGS. 2 & 4, dispensing end 22 which extends downstream of distal end 23 of hose 20 is employed to controllably dispense pressurized fire suppressant materials contained in vessel 12 along a desired path on or adjacent ground level to create a fire break. Hose 20 which terminates at distal end 23 is connected to an end fitting 52 of valve 50 that controllably actuates a valve member in response to a pilot-operated control (not shown) which permits precisely controlled application of pressurized fire suppressant material through a distal end 57 of a dispenser 54, or dispenser head. Valve 50 which may be of any construction so long as the valve member can be actuated to provide suitable flow control for this application, such as a ball valve, preferably is electrically powered by a 24 volt source that is typically utilized for helicopter electrical systems. Electrical power from the power source is transmitted to valve 50 along wire 48 (FIG. 4) that may be secured to the outside of hose 20. A longitudinal groove (not shown) may be formed in hose 20 for insertion of wire 48 therein to minimize the opportunity for “snagging” with terrain obstacles. Alternately, the power source for actuating the valve 50 may be located adjacent valve 50 and configured for wireless control by the pilot. A proximal end 56 of dispenser 54 extends into a fitting 59 having an annular groove 58 formed therein for ease of connection beneath valve 50 which employs a quick release fitting 13 having cam lock fasteners 15 that operate as previously discussed. However, any mechanical arrangement may be used to effect a secure connection between dispenser 54 and value 50. A protective shroud 51 is preferably positioned over dispensing end components 22 to provide impact protection from terrain obstacles encountered while dispensing end components 22 are guided along the terrain at or near ground level. Preferably, shroud 51 is sized to protect dispensing end components 22 from impact with a blunt object or surface from any lateral direction or vertical (from beneath) direction without interfering with the flow of fire suppressant material therefrom. Shroud 51 may be provided with a channel 61 formed therein so that shroud 51 may slide over hose 20, abutting valve 50 or dispenser 54, so long as shroud 51 functions as intended. By utilizing preferably lightweight, strong materials, such as sheet metal or polymers, for constructing shroud 51 or dispenser 54, dispensing end 22 will be extremely durable, “bouncing off” terrain obstacles encountered in use, incurring minimal damage, such use including being drug along the ground for extended distances.

Referring to FIGS. 4 and 9, dispenser heads shall now be discussed. Dispenser head 54 dispenses pressurized fire suppressant in a focused stream through the use of vanes 60. Preferably, dispensing angle 53 from vertical central axis 24 is less than ninety degrees, which makes it possible for dispenser head 54 to dispense a pressurized fire suppressant stream 55 in a desired direction from distal end 57 without interference from shroud 51 while protectively enclosing all dispensing end 22 components therein. Head 54, as well as shroud 51 may be constructed of sheet metal or molded impact resistant polymer materials that are compatible with conventional fire suppressant materials. While the present invention may be adapted for use with any commercially available fire suppressants, a slurry mix of nitrogen-based fire suppressant that includes a bright pigment, such as red for visibility, has been found especially effective for applying to underbrush terrain for creating a fire block. Preferably, a mixing truck (not shown) is provided adjacent the “drop site” to provide the helicopter with a supply of fire suppressant. While head 54 may be utilized to deliver fire suppressant at or along the ground, depending upon various factors including the type of dispensing head employed, to be discussed below, the type and viscosity of fire suppressant used, ambient temperature, pumping system pressure, and possibly the speed of application, head 54 may be maintained anywhere from ground level up to at least three hundred feet above the ground. Preferably, head 54 may be maintained from ground level to about thirty feet above the ground to create the desired fire break under most variations of conditions previously cited. Further as previously discussed, if dispensing angle 53 measures more than zero degrees, that is, at any angle from vertical, and the dispensing head construction does not provide a symmetric application of fire suppressant with respect to axis 24, the exiting fire suppressant subjects head 54 to an opposing lateral reactive force which will act, at least locally, to rotate head 54 slightly away from vertical axis 24, which will direct fire suppressant at an effective angle that is slightly less than depicted angle 53. However, once the reactive forces and gravitational forces acting upon dispensing end 22 reach equilibrium, the slightly modified angle should remain substantially constant and not adversely affect fire suppressant material application by the pilot.

Referring to FIGS. 2, 3, 4, 9, the operation of fire line dispersal system of the present invention shall now be discussed. Once vessel 12 of helicopter 11 has been filled with fire suppressant from the mixer truck as previously discussed, helicopter 11 is maneuvered to the desired application site. The helicopter's on-board pumping system pressurizes the fire suppressant contained within vessel 12, although the valve 50 which is positioned between vessel 12 and tubing segment 42 is maintained in a closed position to prevent flow of the pressurized fire suppressant from vessel 12. Upon positioning dispensing end 22 at the desired height suitable for the particular terrain which may be either adjacent or actually on ground level, the pilot actuates the control that opens the valve 50 which is positioned between vessel 12 and tubing segment 42 to permit the flow of pressurized fire suppressant from vessel 12, through tubing segment 42 and into hose 20. Since the pilot-actuated control also opens the valve 50 adjacent distal end 23, the pressurized fire suppressant flows through hose 20, past valve 50 and through dispenser head 54, being guided between adjacent vanes 60 before exiting distal end 57 in a focused stream for creating a fire break. The pilot then guides the collective dispensing system 22 along a desired path, possibly dragging dispensing system 22 along the ground, dispensing system components 22 being protected from impact with the terrain by shroud 51, creating a continuous fire break, or distinct, multiple fire breaks if desired, since the fire suppressant is dyed bright red permitting tracability. Upon depleting the amount of fire suppressant in vessel 12, or as desired, the pilot may actuate the control to an “off” position which may desirably close the valve 50 adjacent vessel 12 first, permitting fire suppressant in hose 20 to exit dispensing end 22 by force of gravity, or by pressure from the pumping system prior to closing the valve 50 adjacent vessel 12. In any event, helicopter 11 may be returned to the mixing truck to replenish the supply of fire suppressant in vessel 12 prior to resuming the creation of fire breaks along advantageous portions of the terrain.

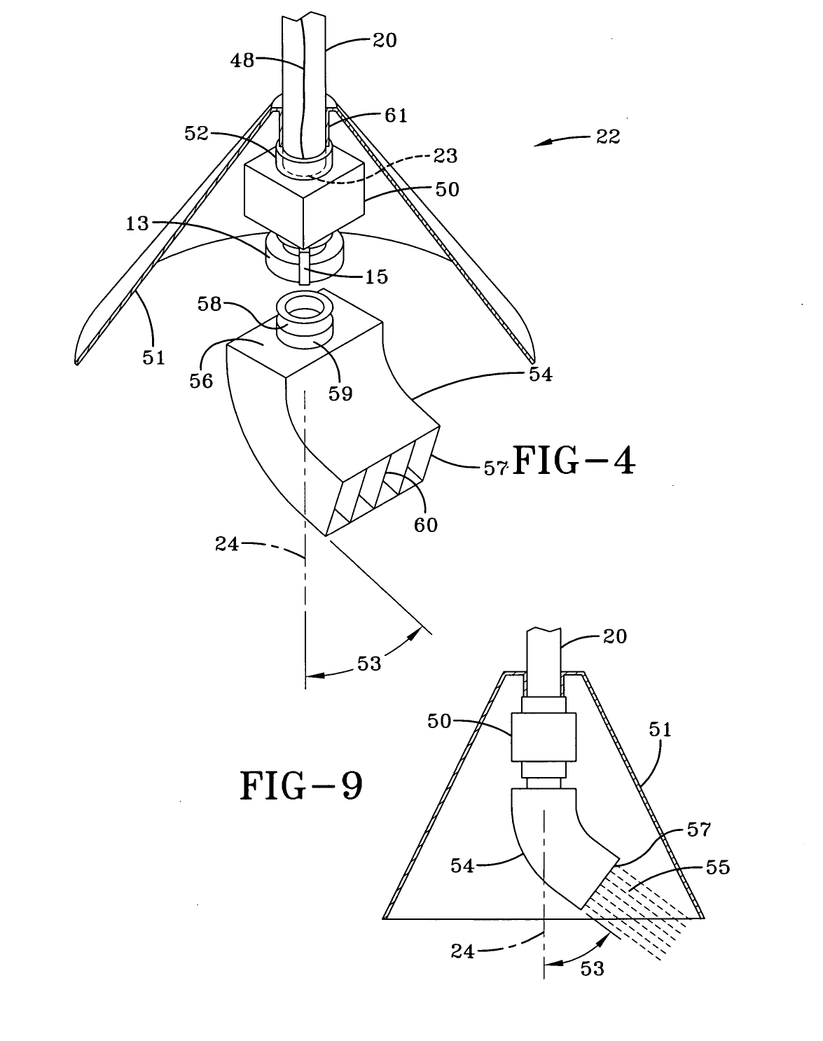

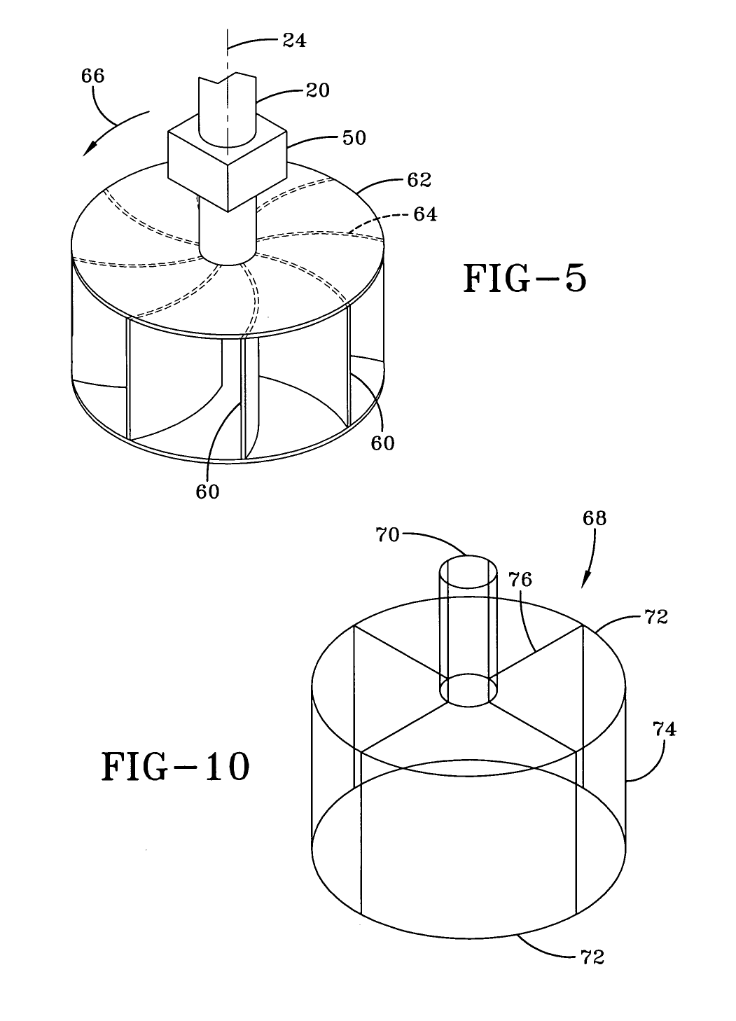

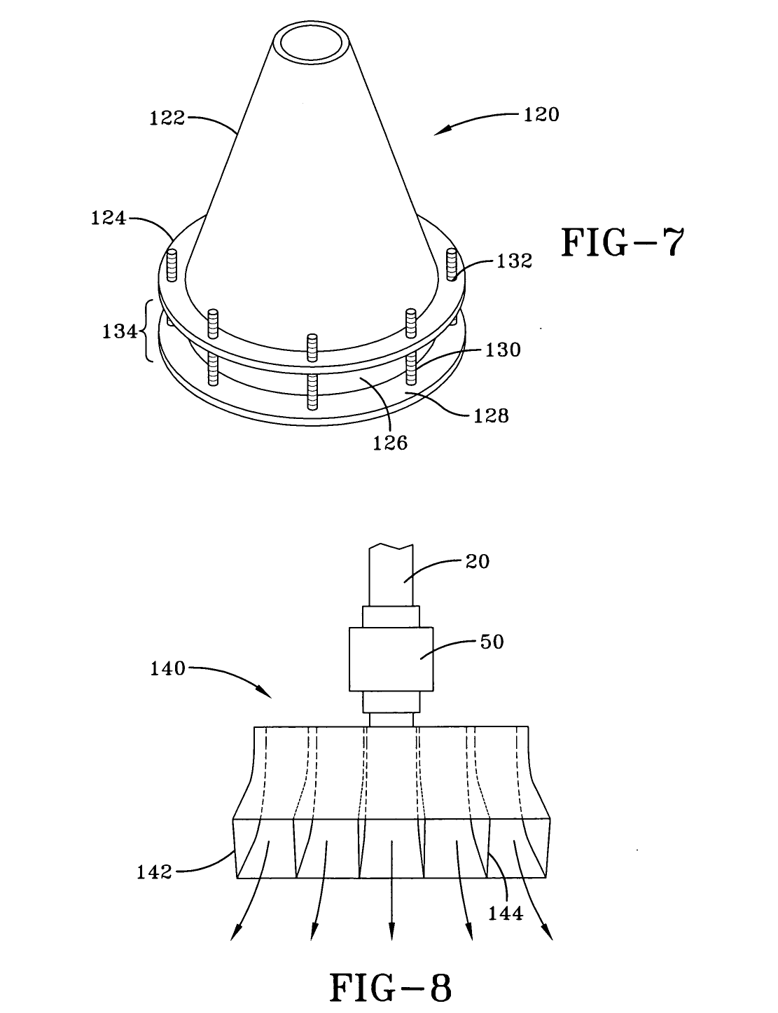

Referring to FIGS. 5 and 10, an alternate embodiment of dispenser cylindrical head 62 includes a plurality of preferably symmetric outwardly extending helical vanes 60 contained therein for uniformly distributing pressurized fire suppressant materials in a 360° pattern about central axis 24. Preferably, pressurized fire suppressant material streams exiting head 62 between helical vanes 60 urges head 62 into rotational movement 66 which provides the uniform distribution. While depicted without an enclosing protective shroud, a wire frame skeleton 68 constructed of interconnecting members 70, 72, 74, 76 may be employed, providing a substantially similar fit, as provided between shroud 51 and head 54 as previously discussed, to provide a measure of impact protection for rotating head 62 from the encountered terrain.

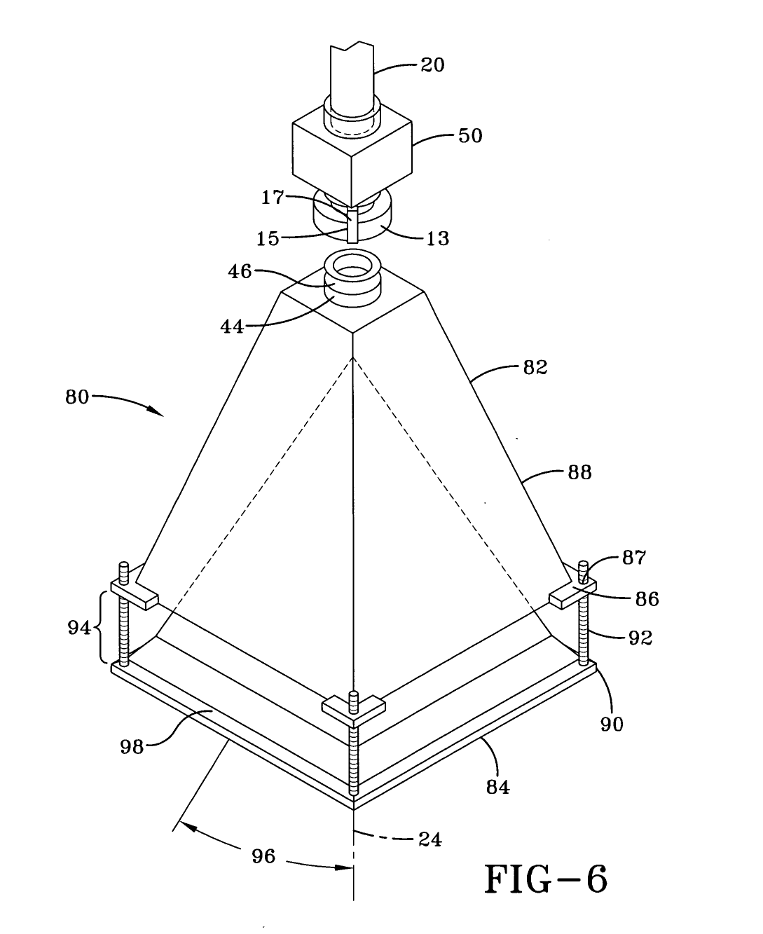

Referring to FIGS. 6 and 7, still further embodiments directed to dispensers shall now be discussed. Distributing head 80 includes an outside housing 82 and an inside housing 84 for directing pressurized fire suppressant therebetween. Preferably, housings 82, 84 employ nested substantially rectangular conical profiles, that is, pyramid-like, having respective aligned corners 88, 90. A surface along flange 98 forming an angle 96 from center axis 24 helps determine the trajectory of the dispensed fire suppressant. To control the flow rate of fire suppressant through distributing head 80, a plurality of fittings 86 extending outwardly from corners 88 are positioned along the edged opening of outside housing 82. Fittings 86 are each provided with threaded apertures 87 for receiving screws 92 in threaded engagement therewith. By actuating screws 92 meshing with threaded apertures 87 in one direction, the screws 92 being rotatably secured with flange 98 formed in inside housing 84, collectively urge housing 82 in a direction away from housing 84 which increases the magnitude of opening 94 for increasing the amount of flow of fire suppressant flowing therebetween for a given pressure. Similarly, actuating screws 92 in the opposite direction collectively urge housing 82 in a direction toward housing 84 which decreases the magnitude of opening 94 for decreasing the amount of flow of fire suppressant flowing therebetween for a given pressure. FIG. 7 depicts an alternate embodiment wherein dispensing head 120 defines a circular conical profile. Housings 122, 126, annular flanges 124, 128, screws 130, threaded apertures 132 and opening 134 are each analogous to housings 82, 84, fittings 86, flange 98, screws 92, threaded apertures 87 and opening 94 and operate in substantially similar fashion to effect flow control of fire suppressant therethrough. Alternately, any other form of controllable fastening means similarly permitting controlled spacing may be utilized. Since quick disconnect fasteners are preferably employed to secure dispenser heads, these heads may be quickly and easily switched to provide the most suitable head construction for the terrain encountered.

Referring to FIG. 8, a distribution head 140 having non-parallel vanes 144 provides a less focused stream of fire suppressant from end 142 than is provided with head 54 (FIG. 4) which may be more desirable for different terrain conditions. Similar to head 62 (FIG. 5), head 140 is not depicted with a protective shroud, but could easily be provided with a wire frame skeleton 68 for terrain impact protection.

One having ordinary skill in the art will realize that although the head constructions depicted contemplate depositing a single stream of fire suppressant for creating a single fire break line so that additional helicopter passes are required to create multiple, preferably parallel fire breaks, it may be possible to achieve multiple streams by either bifurcating the dispensing head and/or arranging the vanes so that the resulting fire suppressant stream diverges. Further, although a circular conical protective shroud is disclosed, any enclosed shape, such as a sphere, may be utilized, so long as an opening is formed therein so as to minimally interfere with the flow of fire suppressant from the dispersing head. Additionally, although spaced nested circular and rectangular housings are disclosed, any number of likewise nested housings of similar geometry may be employed.

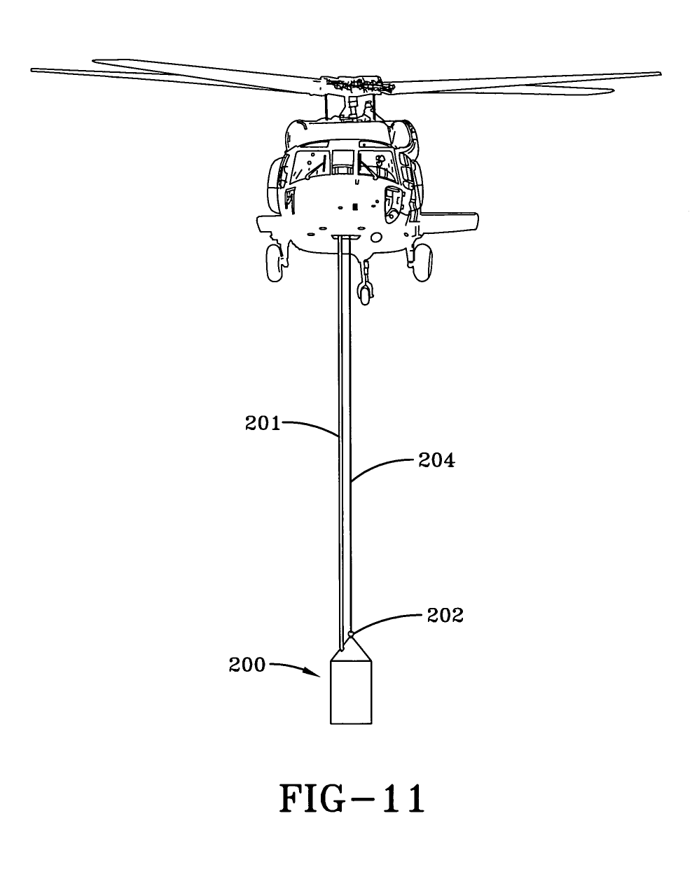

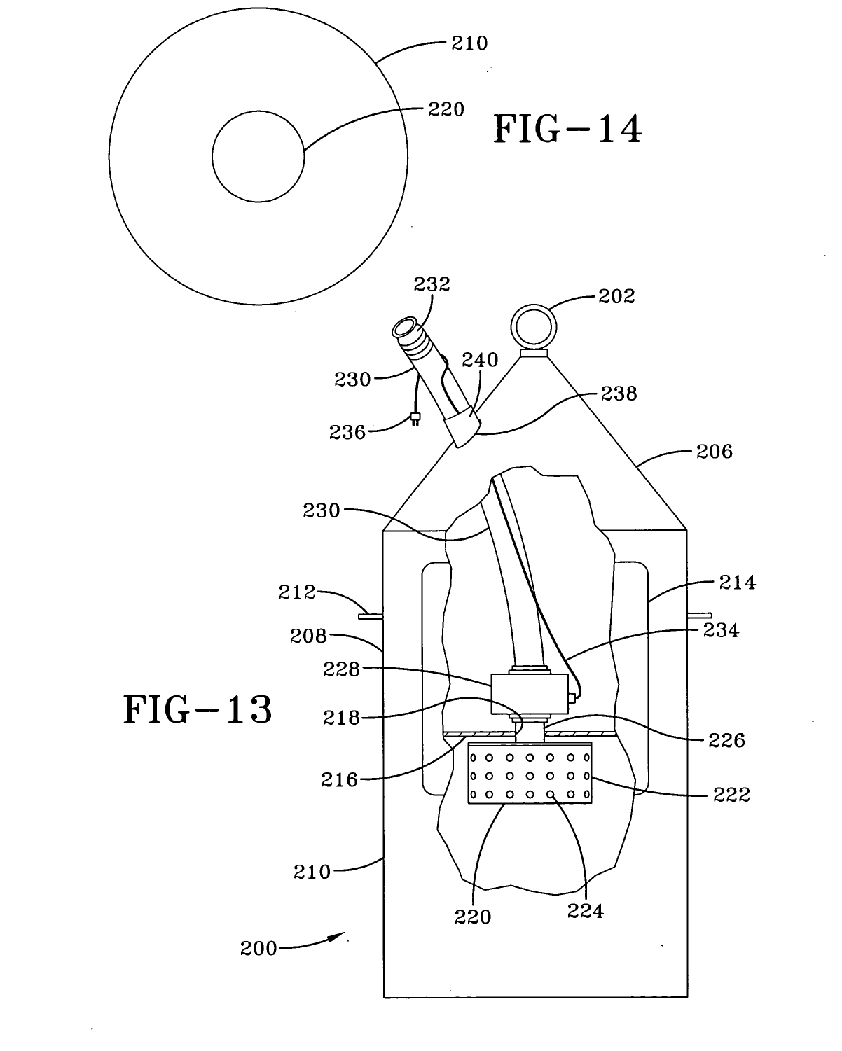

Referring to FIGS. 11-14, an alternate embodiment of a shroud 200 has a ring 202 for carrying the shroud 200 by a cable 204 that is secured to the helicopter belly hook as previously discussed. Fire suppressant is supplied to shroud 200 from the helicopter as previously discussed, passing through hose 201 to a grooved fitting 232 at the end of a hose segment 230. The connection between hose segment 230 and hose 201 preferably being effected by a quick disconnect cam lock design as previously discussed. Electrical wiring (not shown) from the helicopter connects with electrical wiring 234 extending from valve 228 via a plug 236. Circumferential fasteners (not shown), such as nylon tie wraps, secure both hose 201 and the electrical wiring from the helicopter to the cable 204. Thus, as shown in FIG. 12, shroud 200 can be easily disconnected from the rest of the dispersal system.

Shroud 200 comprises a conical top 206 which is connected at one end to ring 202 for lifting shroud 200, and to a first cylindrical portion 208 at the other end. An opening 238 is formed in top 206 so that hose segment 230 and electrical wiring 234 may extend therethrough for respective connection with hose 201 and helicopter electrical wiring. To prevent chafing of hose segment 230 and electrical wiring 234 by opening 238, a protective layer 240, such as hose material, surrounds hose segment 230 adjacent opening 238. Access to valve 228 and hose segment 230 for servicing is provided by a removable access panel 214 that is affixed to first cylindrical portion 208. An opposed pair of lifting handles 212 extending from first cylindrical portion 208 permit convenient handling by ground crews. First cylindrical portion 208 and a second cylindrical portion 210 are separated by a partition 216. A tube segment 226 passing through an opening 218 formed in partition 216 connects valve 228 with dispenser 220. Thus, partition 216 not only secures valve 228 and dispenser 220 in position, but it also separates valve 228 from dispenser 220, keeping fire suppressant from coating valve 228, which makes valve 228 easier to service.

Dispenser 220 is presented at one end of second cylindrical portion 210 that is adjacent first cylindrical portion 208, which surrounds dispenser 220 for protection. The opposite end of second cylindrical portion 210 is open at its other end so that fire suppressant material dispensed from dispenser 220 exits second cylindrical portion 210. Dispenser 220 includes a cover 222 having a plurality of apertures 224 formed therein for dispensing fire suppressant. Unlike the previous dispenser embodiments, dispenser 220 does not require vanes or features for directing streams of fire suppressant, nor does dispenser 220 rotate with respect to shroud 200. Fire suppressant is directed radially outward from apertures 224 in dispenser 220, which would otherwise provide a swath of fire suppressant that is limited by the periphery of the second cylindrical portion. However, due at least in part to draft forces generated by the helicopter blades, the distance between the helicopter and the shroud, the pressure the fire suppressant material is expelled from dispenser 220, and the amount of wind, the size of the swath of fire suppressant may vary considerably. For example, at typical operating pressures and distances between the shroud and the helicopter, the swath is about eight feet in diameter when the dispenser is about 20 to about 25 feet above ground level. This typically provides what is considered an optimum amount of fire suppressant at normal helicopter application travel speeds. Thus, when the helicopter is applying fire suppressant at normal conditions, the swath is preferably about eight feet wide. However, variance in terrain, foliage density, amount of moisture in the foliage, and wind speed or other environmental conditions may significantly affect these values. For example, regions with reduced foliage should still be properly covered by fire suppressant dispensed with the helicopter at up to about 50 feet above ground level.

While the invention has been described with reference to a preferred embodiment, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims.

1. A dispersal system for fire suppression material for use with an airborne craft, the system comprising:
a vessel for holding at least one fire suppressant material therein, the vessel being secured within or adjacent to an airborne craft;
a dispenser for controllably dispensing the at least one fire suppressant material from the vessel; and
a conduit, the conduit having a first end secured in fluid communication with the vessel and a second end adapted for controllably directing the dispensed material adjacent to ground level.

2. The dispersal system of claim 1 wherein the conduit extends from about 50 feet to about 150 feet from beneath the airborne craft.

3. The dispersal system of claim 1 further comprising a release mechanism secured to the airborne craft interposed between the vessel and the conduit for separation of the conduit from the vessel.

4. The dispersal system of claim 1 wherein the dispenser has a plurality of vanes therein for directing dispensed material therethrough.

5. The dispersal system of claim 1 wherein the dispenser symmetrically directs dispensed material about a central axis.

6. The dispersal system of claim 5 wherein the dispenser rotates about the central axis to dispense dispensed material.

7. The dispersal system of claim 1 wherein the dispenser non-symmetrically directs dispensed material in a direction away from a central axis.

8. The dispersal system of claim 1 wherein the dispenser includes a pair of nested housings of similar geometric profiles.

9. The dispersal system of claim 8 wherein the nested housings are controllably spaced to control the amount of material dispensed.

10. The dispersal system of claim 1 wherein the second end may direct the dispensed material in at least one stream.

11. The dispersal system of claim 1 wherein the second end of the conduit comprising a valve and a dispenser head for controllably directing the dispensed material adjacent to ground level.

12. The dispersal system of claim 1 wherein the dispensed material may be dispensed from ground level to about three hundred feet above ground level.

13. The dispersal system of claim 11 wherein the second end of the conduit further comprising a shroud surrounding the valve and dispenser head to provide for the valve and dispenser head.

14. The dispersal system of claim 13 wherein the shroud has a circular conical profile.

15. The dispersal system of claim 13 wherein the shroud has a rectangular conical profile.

16. The dispersal system of claim 11 wherein the dispenser head may direct dispensed material at a dispensing angle measuring from zero degrees from vertical to about ninety degrees from vertical.

17. The dispersal system of claim 11 wherein the dispenser head has a plurality of vanes therein for directing dispensed material therethrough.

18. The dispersal system of claim 11 wherein the dispenser head symmetrically directs dispensing material about a central axis.

19. The dispersal system of claim 18 wherein the dispenser head rotates about the central axis to dispense dispensing material.

20. The dispersal system of claim 11 wherein the dispenser head non-symmetrically directs dispensing material in a direction away from a central axis.

21. The dispersal system of claim 11 wherein the dispenser head includes a pair of nested housings of similar geometric profiles.

22. The dispersal system of claim 21 wherein the nested housings are controllably spaced to control the amount of material dispensed.

23. A dispersal system for fire suppression comprising:
an airborne craft;
a vessel for holding at least one fire suppressant material therein, the vessel being secured within or adjacent to the airborne craft;
a dispenser for controllably dispensing the at least one fire suppressant material from the vessel;
a conduit, the conduit having a first end secured in fluid communication with the vessel and a second end having a valve and a dispensing end for controllably directing the dispensed material adjacent to ground level;
a shroud surrounding the valve and dispenser head; and
a release mechanism secured to the airborne craft interposed between the vessel and the conduit for separation of the conduit from the airborne craft.

24. The dispersal system of claim 23 wherein a swath of fire suppressant material exiting the shroud is substantially controlled by a draft generated by the airborne craft and an amount of pressure dispensing the fire suppressant material from the dispenser.

25. The dispersal system of claim 23 wherein a portion of the shroud surrounding the valve and dispenser head has a cylindrical profile.

26. The dispersal system of claim 23 wherein the shroud further includes a partition for separating the valve and the dispenser.

27. The dispersal system of claim 23 wherein the shroud is from 0 to about 50 feet above ground level.

28. The dispersal system of claim 23 wherein the shroud is from about 20 to about 25 feet above ground level.
